(19) United States
(12) Patent Application Publication
(10) Pub. No.: US 2010/0134608 A1
(43) Pub. Date: Jun. 3, 2010

(54) ENDOSCOPE SYSTEM WITH SCANNING FUNCTION

(75) Inventor: Yuichi SHIBASAKI, Saitama (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/624,514

(22) Filed: Nov. 24, 2009

(30) Foreign Application Priority Data
Dec. 1, 2008 (JP) 2008-306542

(51) Int. Cl. H04N 7/18

(52) U.S. Cl. 348/68; 348/E07.085

(57) ABSTRACT

An endoscope system is equipped with a light source system configured to emit illumination light, a scanner configured to periodically scan the illumination light over a target area at predetermined time intervals by vibrating the tip portion of a scanning fiber, and an imager configured to receive the illumination light reflected from the target and to acquire image data corresponding to an observation image. The endoscope system further has an illumination controller that controls the light source system to emit first illumination light having a first spectrum characteristic during a scan interval, and to emit a second illumination light having a second spectrum characteristic during a return interval.

### BACKGROUND OF THE INVENTION

1. Field of the Invention

The present invention relates to an endoscope system that scans illumination light over a target to be observed, such as tissue. In particular, it relates to an illumination of an observation target.

2. Description of the Related Art

An endoscope system with scanning functionality is equipped with a scanning fiber, such as a single mode type of fiber, which is provided in an endoscope. As described in U.S. Pat. No. 6,294,775 and U.S. Pat. No. 7,159,782, the tip portion of the scanning fiber is held by an actuator, such as a piezoelectric device, that vibrates the tip portion spirally by modulating and amplifying the amplitude (waveform) of the vibration. Consequently, illumination light, passing through the scanning fiber, is spirally scanned over an observation area.

Light reflected off the observation area enters into an image fiber and is transmitted to a processor via the image fiber. The transmitted light is transformed to image-pixel signals by photosensors. Then, each one of the image-pixel signals detected in time-sequence is associated with a scanning position. Thus, a pixel signal in each pixel is identified and image signals are generated. The spiral scanning is periodically carried out on the basis of a predetermined time-interval (frame rate), and one frame's worth of image pixel signals are successively read from the photosensors in accordance with the frame rate.

After a spiral scan for obtaining one frame's worth of a circular image is complete, the fiber tip portion returns from a scanning finish position to a scanning start position in a remaining frame interval (hereinafter, this interval is called a “return interval”). At this time the fiber tip portion, which has been largely deflected, rapidly returns to the central position. Because of the rapid movement of the fiber tip portion, precise control of a scanning position in the return interval is difficult. As a result, image data in the return interval cannot be utilized directly because it does not have the same image quality as the image data obtained in the spiral scan interval.

Also, when utilizing a scanning fiber with a conventional endoscope system, illumination light for scanning is super-imposed on normal illumination light that is emitted from a light source, such as a halogen lamp. This makes it difficult to obtain a special image using the scanning fiber.

### SUMMARY OF THE INVENTION

An object of the present invention is to provide an endoscope system that is capable of acquiring an observation image necessary for diagnosis by effectively illuminating a target area.

An endoscope system according to the present invention is equipped with a light source system configured to emit illumination light, a scanner configured to periodically scan the illumination light over a target area at predetermined time intervals by vibrating the tip portion of a scanning fiber, and an imager configured to receive the illumination light reflected from the target and to acquire image data corresponding to an observation image.

The endoscope system further has an illumination controller that controls the light source system to emit first illumination light having a first spectrum characteristic during a scan interval, and to emit a second illumination light having a second spectrum characteristic during a return interval. The scan interval represents an interval during which the fiber tip portion moves along a spiral course. On the other hand, the return interval represents an interval during which the fiber tip portion returns directly to a scanning start position.

In the present invention, an observation image that is different from an image according to the scan interval is obtained during the return interval. Even though image quality of the return-interval image is insufficient compared to the image quality of the scan interval, this image can be utilized to diagnose tissue in combination with the image of the scan interval. Also, the image of the return interval can meet its image quality requirement by decreasing a frame rate.

During the return interval, the fiber tip portion generally vibrates adjacent to a center axis that corresponds to a central area of an observation image. Therefore, the illumination controller may illuminate the center portion of an observation image with the second illumination light. Thus, reliable image information necessary for observation is acquired.

For example, the first illumination light may be set to light having a spectrum in a range of short wavelengths, such as excitation light. Considering that luminance data in the return interval is useful, the second illumination light may be set to light having a generally uniform spectrum over the entire range of wavelengths, such as white light. Thus, an operator can compare unique area in an observation image obtained by first illumination light with a corresponding area in a normal observation image obtained by the second illumination light.

When a luminance difference occurs between two images, the possibility of tissue is high. The endoscope may be equipped with a luminance detector that detects a first luminance level of a first image that is obtained by the first illumination light illuminated during the scan interval, and that detects a second luminance level of a second image that is obtained by the second illumination light illuminated during the return interval; and a correcting processor that carries out an image processing or brightness adjustment when a luminance difference between the first luminance level and the second luminance level exceeds a threshold level. Especially, the correcting processor may carry out the image processing when the first luminance level is larger than the second luminance level and the luminance difference exceeds the threshold level. Also, considering that a central area of an observation image is mainly illuminated in the return interval, the luminance detector detects the first luminance level from a central area of the first image.

An apparatus for controlling illumination light in an endoscope system with a scanning unit, according to another aspect of the present invention, has a first illumination controller that allows a light source to emit first illumination light having a first spectrum characteristic in a scan interval where the fiber tip portion spirally moves; and a second illumination controller that allows the light source to emit second illumination light having a second spectrum characteristic in a return interval where the fiber tip portion returns to a scanning start position.

A computer-readable medium that stores a program for controlling illumination light in an endoscope system with a scanning unit, according to another aspect of the present invention, has a first illumination code segment that allows a light source to emit first illumination light having a first spectrum characteristic in a scan interval where the fiber tip portion spirally moves; and a second illumination code segment that allows the light source to emit second illumination light having a second spectrum characteristic in a return interval where the fiber tip portion returns to a scanning start position.

A method for controlling illumination light in an endoscope system with a scanning unit, according to another aspect of the present invention, includes: a.) allowing a light source to emit first illumination light having a first spectrum characteristic in a scan interval where the fiber tip portion spirally moves; and b.) allowing the light source to emit second illumination light having a second spectrum characteristic in a return interval where the fiber tip portion returns to a scanning start position.

An endoscope system according to another aspect of the present invention is capable of obtaining an image by scanning illumination light while utilizing a conventional endoscope system. The endoscope system is equipped with a first illuminator that is configured to uniformly and continuously illuminate first observation light over a target area; a second illuminator that is configured to illuminate scanning illumination light, which is different from the normal observation light, over the target area while periodically scanning the scanning illumination light over the target area; and an illumination controller that suspends illumination of the scanning illumination light during a return interval. The return interval is an interval from the finish of a scan interval to the start of a subsequent scan interval that contains one frame's worth of an image.

The endoscope system further has a luminance detector that detects both a first luminance level of the return interval and a second luminance level of the scan interval, and an image signal processor that generates image data of the scanning illumination light on the basis of a difference between and the first and second luminance level.

### BRIEF DESCRIPTION OF THE DRAWINGS

The present invention will be better understood from the description of the preferred embodiments of the invention set forth below together with the accompanying drawings, in which:

FIG. 1 is a block diagram of an endoscope system according to a first embodiment;

FIG. 2 illustrates a scanning optical fiber and scanning unit schematically;

FIG. 3 is a view showing a vibration of the fiber tip portion and an observed image in the concurrent observation mode;

FIG. 4 is a flowchart of an illumination process and image-processing in the concurrent observation mode;

FIG. 5 is a view showing a fluorescence observation image and a normal observation image;

FIG. 6 is a block diagram of an endoscope system according to the second embodiment; and

FIG. 7 is a view showing a timing of illumination.

### DESCRIPTION OF THE PREFERRED EMBODIMENTS

Hereinafter, the preferred embodiments of the present invention are described with reference to the attached drawings.

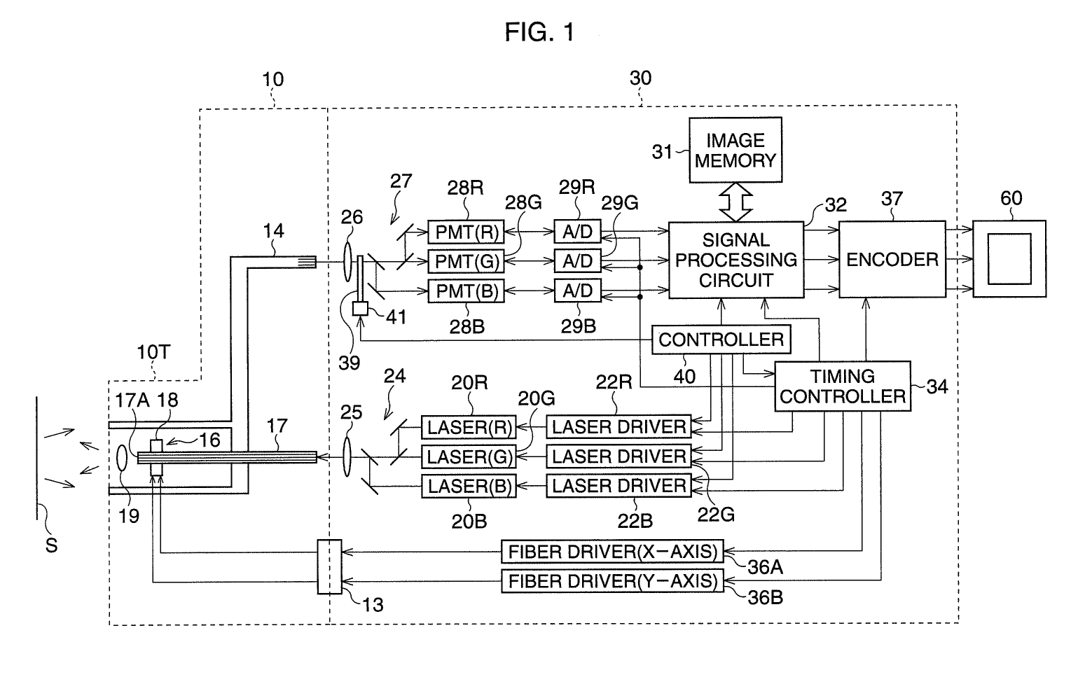

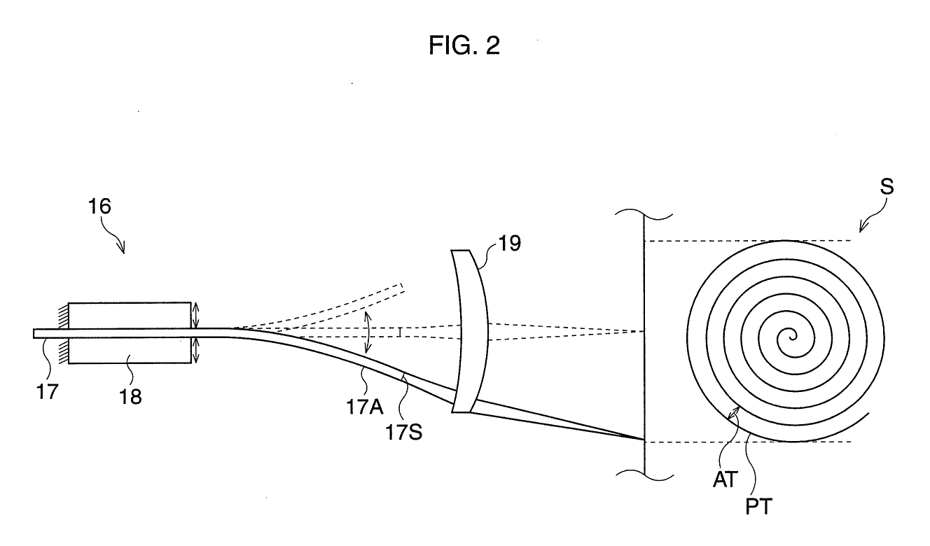

FIG. 1 is a block diagram of an endoscope system according to a first embodiment. FIG. 2 illustrates a scanning optical fiber and scanning unit schematically.

The endoscope system is equipped with a processor 30 and an endoscope 10 that includes a scanning fiber 17 and an image fiber 14. The single mode type of scanning fiber 17 transmits illumination light, whereas the image fiber 14 transmits light reflected off of an observation target such as tissue. The endoscope 10 is detachably connected to the processor 30, which is connected to the monitor 60.

The processor 30 has three lasers 20R, 20G, and 20B, which emit red, green, and blue light, respectively, and are driven by three laser drivers 22R, 22G, and 22B, respectively. Red, green and blue light is simultaneously emitted from lasers 20R, 20G, and 20B, and is collected by half-mirror sets 24 and a collection lens 25. Consequently, white light enters into the scanning fiber 17 and travels to the tip portion 10T of the endoscope 10. The light exiting from the scanning fiber 17 illuminates a target S to be observed.

Usually, an operator uses the fiber scope 10 in a normal observation mode, namely, in a condition of continuous illumination with white light, thus a full color image is displayed. However, an operator can further select a fluorescence observation mode, and a concurrent observation mode by operating a keyboard (not shown) connected to the video processor 30. In the fluorescence observation mode, a target area is continuously illuminated with excitation light having short wavelengths. Herein, only the laser 20B is driven to emit blue light as “excitation light”. Thus, an observation image of the target area that is based on fluorescence is displayed on the monitor 60 (hereinafter, called a “fluorescence observation image”). An operator can find tissue, such as a cancer, easily.

In the concurrent observation mode, as described later, excitation light and white light are emitted, in order, in each frame interval. Then, excitation light and white light enters in the scanning fiber 17 through the half-mirror sets 24 and the collection lens 25, and exits from the scope tip portion 10T, in order. Consequently, a normal observation image and a fluorescence observation image are displayed simultaneously.

As shown in FIG. 2, a scanning unit 16 is provided in the tip portion 10T of the video scope 10. The scanning unit 16 has a cylindrical actuator 18 and scans illumination light over a target S. The optical fiber 17 passes through the axis of the actuator 18 and the tip portion 17A of the scanning optical fiber 17, which cantilevers from the actuator 18 and is supported by the actuator 18.

The actuator 18 fixed at the distal end 10T of the video-scope 10 is a piezoelectric tubular actuator that resonates the tip portion 17A of the optical fiber 17 in two dimensions. Concretely, the actuator vibrates the tip portion 17A with respect to two axes that are perpendicular to one other, in accordance with a resonant mode. The vibration of the tip portion 17A spirally displaces the position of the end surface 17S from the axial direction of the optical fiber 17.

The light emitted from the end surface 17S of the optical fiber 17 passes through an objective lens 19 before reaching the target S. A pattern traced by a scanning beam, i.e., a scan line PT forms a spiral pattern (see FIG. 2). Since a spiral interval in a radial direction is tight, the total observation area S is illuminated by spirally scanned light.

In the case of white light, light reflected from the target S enters the image fiber 17 and is transmitted to the processor 30. When the reflected light exits from the image fiber 17, it is divided into R, G, and B light by an optical lens 26 and half-mirror sets 27. The separated R, G, and B light then continue on to photosensors 28R, 28G, 283, respectively, which transform the R, G, and B light to image-pixel signals corresponding to R, G, and B.

When emitting excitation light, an elimination filer 39 is moved from the outside of an optical path to the inside of the optical path by an actuator 41. Thus, reflection light of excitation light is eliminated. Fluorescence emitted from the target area S enters into the photosensor 28B so that image-pixel signals corresponding to fluorescence are generated. In the concurrent observation mode, the elimination filter 39 is positioned in the optical path during the emission of excitation light.

The generated analog image-pixel signals, corresponding to R, G, and B, (or fluorescence), are converted to digital image-pixel signals by A/D converter 29R, 29G, and 29B, then fed into a signal processing circuit 32, in which a mapping process is carried out. The successively generated digital image-pixel signals are arrayed in accordance to the order of a spiral scanning pattern. In the mapping process, each of the digital image-pixel signals are associated with a corresponding scanning position so that raster-arrayed image-pixel signals are formed when scanning is carried out. Consequently, the pixel position of each of the digital image-pixel signals is identified in order, and one frame's worth of digital image-pixel signals are generated.

The generated two-dimensional digital image-pixel signals are subjected to various image processing, including a white balance process so that video signals are generated. The generated video signals are sent to the monitor 60 via an encoder 37, thus an observed image is displayed on the monitor 60.

A system controller 40, which includes a ROM unit, a RAM unit, and a CPU, controls the action of the video processor 30 and the videoscope 10 by outputting control signals to the signal processing circuit 32, a timing controller 34, the laser driver 22R, 22G, and 22B, etc. A control program is stored in the ROM unit. The timing controller 34 outputs synchronizing signals to fiber drivers 36A, 36B for driving the scan unit 16, and the laser drivers 22R, 22G, and 22B to synchronize the vibration of the tip portion 17A with the timing of the emission of light.

The output of lasers 20R, 20G, and 20B is controlled by driving signals fed from the laser drivers 22R, 22G, and 22B. Thus, an amount of illumination light (intensity of light) incident on a target is adjustable. In the signal processing circuit 32, luminance signals are generated from the digital image-pixel signals and are transmitted to the system controller 40. The system controller 40 outputs control signals to the laser drivers 22R, 22G, and 22B to adjust an amount of illumination light. Thus, a proper brightness is maintained.

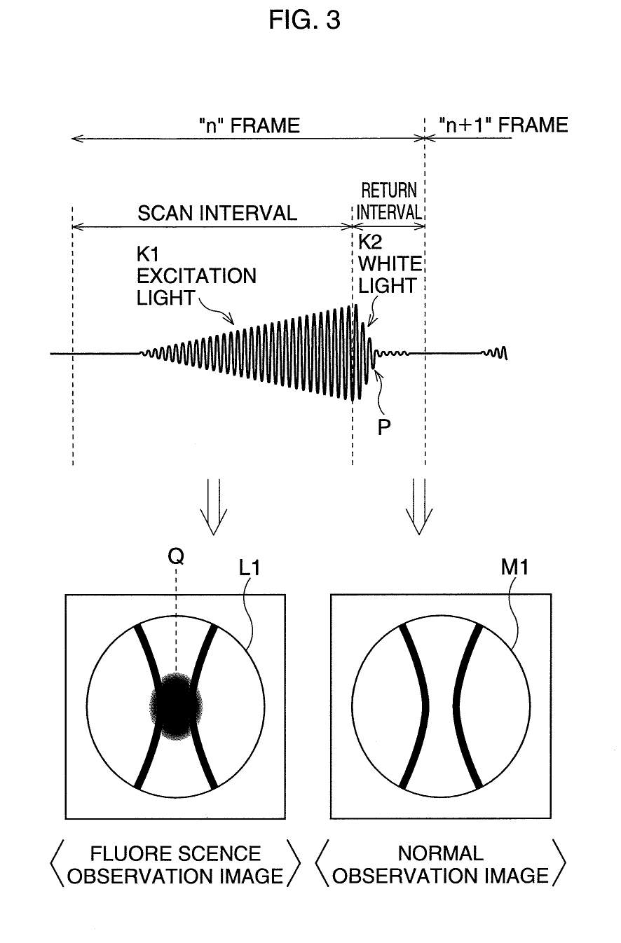

FIG. 3 is a view showing a vibration of the fiber tip portion and an observed image in the concurrent observation mode.

A spiral scan according to the vibration of the fiber tip portion 17T is periodically performed at a given frame rate. One frame interval can be divided into a scan interval “K1” for obtaining one frame's worth of an observation image and a return interval “K2” where the fiber tip portion 17A returns to a scan start point (i.e., a center position along the axis of the optical fiber 17) in order to start scanning illumination light in a subsequent frame interval.

In FIG. 3, amplitudes of the fiber tip portion 17A along horizontal (or vertical direction) are shown. In the scan interval, the fiber tip portion 17A spirally resonates from the center position to a final scan position. The fiber tip portion 17A deflects to the greatest extent at the final scan position, and is forced to return instantaneously to the center position in the very short return interval. The fiber tip portion 17A rapidly returns to the center position with decay vibration.

In the scan interval “K1”, one frame's worth of a fluorescence observation image L1 is obtained under the illumination of excitation light. If an observation area includes tissue such as cancer, fluorescence is not irradiated from the tissue. Consequently, an area Q having a relatively low luminance level is exhibited.

On the other hand, white light is emitted in the return interval “K2” so that a normal observation image is displayed. The vibration of the fiber tip portion 17A in the return interval “K2” is not stable because the fiber tip portion 17A is forced to return to the center position rapidly. Accordingly, it is difficult to map scanning positions with the pixel positions of detected image-pixel signals. Also, an image obtained by the return interval “K2” does not have sufficient image quality necessary for diagnosing tissue.

However, the fiber tip portion 17A vibrates at a position adjacent to the center position during the return interval “K2”, as shown by an arrow P. Namely, white light mostly illuminates a central portion of a target area. Therefore, the normal observation image can be utilized to acquire precise luminance data of the central portion.

In the case of the fluorescence observation image L1, it is difficult to determine whether a low luminance area corresponds to a tissue area or merely to a relief portion (concave portion) that causes a low luminance area. This is because intensity of excitation light is weak.

However, if the low luminance area is in the central portion of the fluorescence observation image L1, and the central portion of the normal observation image M1 obtained by white light is not a low-luminance area, the possibility that the central low-luminance area corresponds to tissue is high. Herein, if a luminance difference exists between the normal observation image M1 and the fluorescence observation image L1, it indicates that tissue exists in a target area. Then, image processing for clearing a tissue portion is carried out.

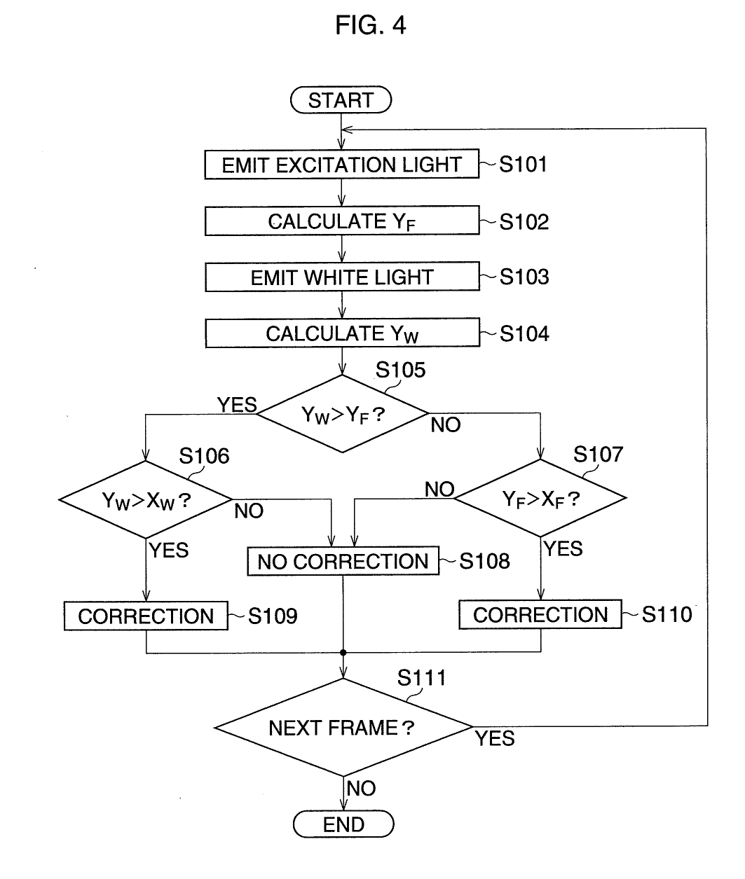

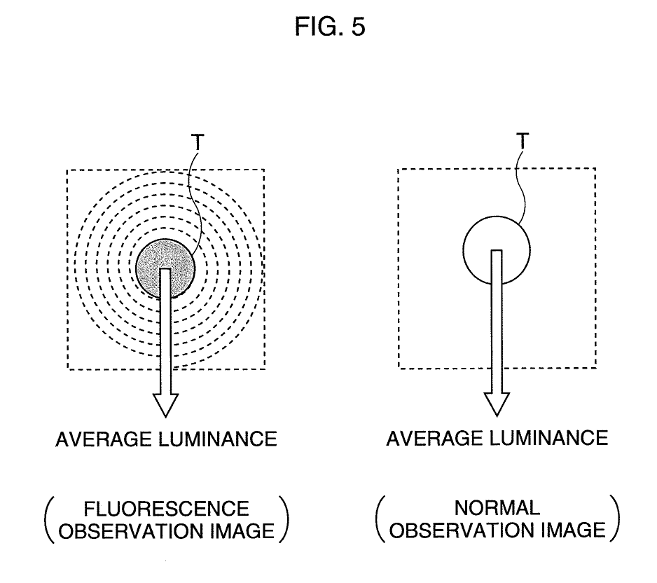

FIG. 4 is a flowchart of an illumination process and image-processing in the concurrent observation mode. FIG. 5 is a view showing a fluorescence observation image and a normal observation image.

In Step S101, the laser drivers 22R, 22G, and 22B are controlled so as to emit only excitation light. In Step S102, an average luminance level Y_{F} is calculated from a sequence of luminance data obtained during a scan interval. The average luminance level Y_{F} represents an average luminance value of the central area T of the fluorescence observation image L1 (hereinafter called a “luminance calculation area”) .

In FIG. 5, the luminance calculation area T for calculating the average luminance level Y_{F} is shown. The luminance area T is a circular area having a center position corresponding to a scan start point, and is defined on the basis of an area that is illuminated by white light in the return interval.

In Step S103, the laser drivers 22R, 22G, and 22B are controlled so as to emit white light after the end of the scan interval. Then, in Step S104, an average luminance level Y_{W} of the luminance calculation area T of the normal observation image M1 is calculated.

In Step S105, it is determined whether the average luminance level Y_{W} of the normal observation image is larger than the average luminance level Y_{F} of the fluorescence observation image. When it is determined that the average luminance level Y_{W} is larger than the average luminance level Y_{F}, the process proceeds to Step S106, in which it is determined whether the average luminance level Y_{W} of the normal observation image is larger than a threshold level X_{W}. When the average luminance level Y_{W} is larger than the threshold level X_{W}, the possibility that tissue exists in the luminance calculation area (the central portion) T is determined to be high, and the process proceeds to Step S109.

In Step S109, an image correction process is carried out on the fluorescence observation image. Concretely, a contour enhancement process is carried out in the signal processing circuit 32 in which an operator diagnoses a degree of tissue from the fluorescence observation image displayed on the monitor 60.

On the other hand, when it is determined at Step S106 that the average luminance level Y_{W} is equal to or smaller than the threshold level X_{W}, it is regarded that a substantial luminance difference between the normal observation image and the fluorescence observation image does not exist. In this condition, an image correction process is not carried out (S108).

When it is determined at Step S105 that the average luminance level Y_{W} of the normal observation image is not larger than the average luminance level Y_{F} of the fluorescence observation image Y_{F}, the process proceeds to Step S107, in which it is determined whether the average luminance level Y_{F} is larger than a threshold X_{F}.

When it is determined that the average luminance level Y_{F} is not larger than the threshold X_{F}, it is regarded that the luminance difference between “Y_{F}” and “Y_{W}” does not exist, and the image correction process is not carried out. On the other hand, when the average luminance level Y_{F} is larger than the threshold level X_{F}, it is determined that an abnormality exist in the central portion. Then, the image correction process is carried out (S110). Even though fluorescence is herein emitted from the central portion of a target area, the image correction process is carried out to diagnose the unique portion with respect to luminance levels. Note that the image correction process may not be carried out at Step S110 if the existence of a particular high-luminance area is not important for diagnosis.

When a spiral scan in the subsequent frame interval is deemed necessary (Step 111), the process returns to Step S101, and Steps S101-S111 are repeated.

In this way, the endoscope system according to the present embodiment has the scanning fiber 17 that scans an observation area with illumination light. In the concurrent observation mode, the system controller 40 controls the laser drivers 22R, 22G, and 22B so as to emit excitation light in the scan interval “K1” and normal white light in the return interval “K2”, in that order. When a luminance difference between the fluorescence observation image and the normal observation image occurs in the luminance calculation area T, the image correction process is carried out. Thus, contours of tissue are clearly displayed in the fluorescence observation image L1 so that an operator can accurately diagnose different degrees of tissue.

A brightness adjustment process that adjusts an amount of illumination light may be applied instead of the image correction process. In this case, the brightness adjustment is carried out on the basis of an average luminance level that is detected in a previous frame interval. An area other than the central circular area T may be defined for detecting a luminance level, based on the movement of the fiber tip portion in the return interval.

Furthermore, the image correction process or brightness adjustment based on the luminance difference may not be carried out, i.e., only the concurrent display of the fluorescence observation image and the normal observation image may be carried out. An operator may diagnose tissue by comparing the normal observation image to the fluorescence observation image.

White light may be illuminated for only part of the entire return interval. In this case, excitation light may be illuminated for a given interval in accordance to the illumination interval of white light. Also, white light may be illuminated during the scan interval. In this case, excitation light may be illuminated during the return interval.

Furthermore, illumination light other than excitation light or white light may be used during the scan interval and the return interval. For example, when observing a capillary in a deep layer of an organ's inner wall, light with a wavelength near 500 nm may be illuminated in a scan interval. As for the scan method, a given scan other than a spiral scan may be carried out.

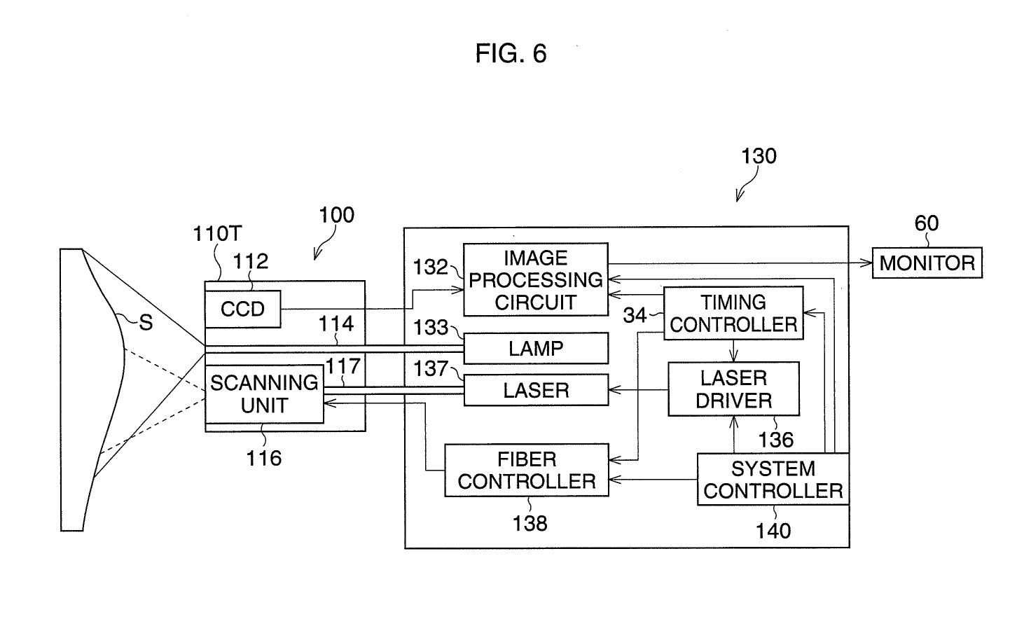

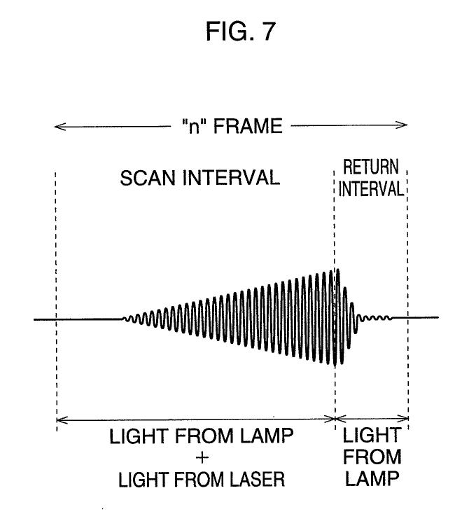

Next, the second embodiment is explained with reference to FIGS. 6 and 7. The second embodiment is different from the first embodiment in that a video scope with a scanning fiber is used and two light sources are provided.

FIG. 6 is a block diagram of an endoscope system according to the second embodiment.

A video processor 130, connected to a video scope 100, is equipped with a lamp 133 for normal observation and a laser 137 for special observation. A controller 140 in the video processor 130 controls the action of the video processor 130. Light emitted from the lamp 133 passes through a light guide 14, which is composed of a fiber-optic bundle, and exits from the scope tip portion 10T. Thus, an entire target area is uniformly illuminated by illumination light.

Light reflected from the target area S enters a light-receiving area of a CCD 12 so that an object image is formed on the light-receiving area. Herein, an on-chip color filter method is applied as the image processing method. A complementary color filter (not shown), composed of four color elements—Yellow (Y), Magenta (Mg), Cyan (Cy), and Green (G), is arranged in a checkered pattern such that each element of the four color elements is opposite a pixel. In the CCD 54, based on light passing through the complementary color filter, image-pixel signals are generated by the photoelectric effect. The analog image-pixel signals are read from the CCD 54 at regular time intervals (for example, 1/60- or 1/50-second intervals).

The image-pixel signals are subjected to an amplification process, an A/D conversion process, and a noise reduction process in an initial processing circuit (not shown). Next, digital image signals are subjected to a white balance process, a gamma correction process, etc., in a signal processing circuit 132. Consequently, video signals are generated and sent to the monitor 60.

The tip portion of a scanning fiber 117 is vibrated two-dimensionally by a scanning unit 116 so that a target area S is spirally scanned with illumination light. The illumination light emitted by a laser 137 is light with short wavelengths. When an operator operates the keyboard to diagnose a specific portion in detail, the specific portion is illuminated with laser light. The scanning unit 116 is controlled by a fiber controller 138 so as to periodically resonate the fiber tip portion with an appropriate timing for reading the image-pixel signals.

FIG. 7 is a view showing a timing of illumination. During the scan interval, white light from the lamp 133 and short-wavelength light from the laser 137 are simultaneously emitted. On the other hand, only white light is emitted during the return interval. The laser driver 136 is controlled by the system controller 140 to suspend emission of short-wavelength light.

The signal processing circuit 132 detects the luminance level of each pixel in an image that is obtained by illumination of white light and short-wavelength light during the scan interval, and detects the luminance level of each pixel in an image that is obtained by illumination of only white light during the return interval. Then, the signal processing circuit 132 calculates a difference between the luminance level of mixed light and the luminance level of only white light. Thus, image data based on only short-wavelength light is generated and displayed on the monitor 60.

In this way, the endoscope system having the video-scope with scanning function can display a special image based on a short-wavelength light, in addition to a normal observation image. Thus, an operator can make a diagnosis using both an image generated by a conventional video-scope and image sensor, and a special image that is needed for the detailed observation of specific degrees of tissue.

A probe-type fiber scope with a scanning fiber may be applied instead of the video-scope described in the second embodiment. In this case, the probe-type fiber scope is inserted into forceps provided in a conventional video scope.

As for scanning, illumination light may be scanned by driving an optical lens instead of vibrating the fiber tip portion.

The present disclosure relates to subject matter contained in Japanese Patent Application No. 2008-306542 (filed on Dec. 1, 2008), which is expressly incorporated herein, by reference, in its entirety.

1. An endoscope system comprising:
a light source system configured to emit illumination light;
a scanner configured to periodically scan the illumination light over a target area at predetermined time intervals by vibrating the tip portion of a scanning fiber;
an imager configured to receive the illumination light reflected from the target and to acquire image data corresponding to an observation image; and
an illumination controller that controls said light source system to emit first illumination light having a first spectrum characteristic during a scan interval where the fiber tip portion moves spirally, and to emit a second illumination light having a second spectrum characteristic during a return interval where the fiber tip portion returns to a scanning start position.

2. The endoscope system of claim 1, wherein said illumination controller illuminates the center portion of an observation image with the second illumination light.

3. The endoscope system of claim 1, further comprising:
a luminance detector that detects a first luminance level of a first image that is obtained by the first illumination light illuminated during the scan interval, and that detects a second luminance level of a second image that is obtained by the second illumination light illuminated during the return interval; and
a correcting processor that carries out an image processing or brightness adjustment when a luminance difference between the first luminance level and the second luminance level exceeds a threshold level.

4. The endoscope system of claim 3, wherein said correcting processor carries out the image processing when the first luminance level is larger than the second luminance level and the luminance difference exceeds the threshold level.

5. The endoscope system of claim 4, wherein said luminance detector detects the first luminance level from a central area of the first image.

6. The endoscope system of claim 1, wherein the first illumination light is light having a spectrum in a range of short wavelengths.

7. The endoscope system of claim 1, wherein the second illumination light is light having a generally uniform spectrum over the entire range of wavelengths.

8. An apparatus for controlling illumination light in an endoscope system with a scanning unit, comprising:
a first illumination controller that allows a light source to emit first illumination light having a first spectrum characteristic in a scan interval where the fiber tip portion spirally moves; and
a second illumination controller that allows said light source to emit second illumination light having a second spectrum characteristic in a return interval where the fiber tip portion returns to a scanning start position.

9. A computer-readable medium that stores a program for controlling illumination light in an endoscope system with a scanning unit, comprising:
a first illumination code segment that allows a light source to emit first illumination light having a first spectrum characteristic in a scan interval where the fiber tip portion spirally moves; and
a second illumination code segment that allows said light source to emit second illumination light having a second spectrum characteristic in a return interval where the fiber tip portion returns to a scanning start position.

10. A method for controlling illumination light in an endoscope system with a scanning unit, comprising:
allowing a light source to emit first illumination light having a first spectrum characteristic in a scan interval where the fiber tip portion spirally moves; and
allowing said light source to emit second illumination light having a second spectrum characteristic in a return interval where the fiber tip portion returns to a scanning start position.

11. An endoscope system comprising:
a first illuminator configured to uniformly and continuously illuminate a target area with normal observation light;
a second illuminator configured to illuminate the target area with scanning illumination light different from the normal observation light, while periodically scanning the target area with scanning illumination light;
an illumination controller that suspends illumination with the scanning illumination light during a return interval, the return interval being an interval from the finish of one scan interval to the start of a subsequent scan interval that contains one frame's worth of an image;
a luminance detector that detects a first luminance level of the return interval and a second luminance level of the scan interval; and
an image signal processor that generates image data from the scanning illumination light on the basis of a difference between the first luminance level and the second luminance level.
